(19) United States
(12) Patent Application Publication
(10) Pub. No.: US 2025/0329908 A1
(43) Pub. Date: Oct. 23, 2025

(54) MILLIMETER-WAVE BANDPASS FILTER

(71) Applicant: The Hong Kong University of Science and Technology, Hong Kong (CN)

(72) Inventors: Yansong Yang, Hong Kong (CN); Qun Li, Hong Kong (CN)

(21) Appl. No.: 19/169,231

(22) Filed: Apr. 3, 2025

Related U.S. Application Data
(60) Provisional application No. 63/636,122, filed on Apr. 19, 2024.

(51) Int. Cl. H01P 1/201; H01P 1/203; H01P 3/00; H01P 7/08

(52) U.S. Cl. CPC H01P 1/2013; H01P 1/20381; H01P 3/003; H01P 7/086

(57) ABSTRACT

A coplanar waveguide based (CPW-based) millimeter-wave (mmWave) bandpass filter is disclosed. The filter may comprise a substrate, first and second ground metal plates, an input signal transmission line and an output signal transmission line, and four half-wavelength CPW resonators. A T-slot or an I-slot is optionally embedded into each CPW resonator to improve the suppression at the upper stopband. Optionally, the filter may further comprise two T-stubs respectively connected to the first and second ground metal plates to reduce the size of the filter and generate transmission zeros in the lower stopband. Optionally, the filter may further comprise a cross-shaped dual-mode resonator in a central area of a CPW plane to increase the bandwidth of the filter. The proposed CPW-based mmWave bandpass filter(s) can achieve low passband insertion loss, high out-band suppression, miniature size, and low cost.

### CROSS-REFERENCE TO RELATED APPLICATIONS

This application claims priority to, and the benefit of, U.S. Provisional Patent Application Ser. No. 63/636,122 filed Apr. 19, 2024, the disclosure of which is incorporated by reference herein in its entirety.

### FIELD OF THE DISCLOSURE

The present invention relates to a field of millimeter-wave (mmWave) bandpass filter.

### BACKGROUND

With data rate up to 1 Tbps, latency less than 0.1 ms, and large capacity, fifth to sixth generation (5G-6G) wireless communication systems are expected to commercial applications at around year of 2030. In the era of big data, the 5G-6G wireless communication systems can eventually realize internet of everything (IoE). Portable smart terminals, especially smartphones, are widely used in 5G-6G wireless communication systems. Modern smartphones typically incorporate dozens of filters within their circuitry. The miniaturized mmWave filter, which has a stringent size limit, is required for portable smart terminals or IoE devices. However, the mmWave filter chips with low insertion loss in passband, high stopband suppression level, high roll-off rate, and small size remain challenging and not available worldwide.

### SUMMARY

In one aspect of the disclosure there is provided a coplanar waveguide based (CPW-based) mmWave bandpass filter. The CPW-based mmWave bandpass filter comprises: a substrate; first and second ground metal plates each coupled to ground and disposed on a rectangular CPW plane at a top surface of the substrate; an input signal transmission line and an output signal transmission line respectively positioned at two ends of a signal region in the longitudinal direction and each aligned with a first midline; first and second CPW resonators each longitudinally arranged between the first ground metal plate and a middle signal region; and third and fourth CPW resonators each longitudinally arranged between the second ground metal plate and the middle signal region. The first and second ground metal plates extend continuously from a first end to a second end of the CPW plane along a longitudinal direction of the CPW plane and are positioned on opposite sides of the CPW plane in a transverse direction of the CPW plane, thereby defining the signal region between the first and second ground metal plates. The signal region extends continuously along the longitudinal direction. The first midline is a midline of the CPW plane in the longitudinal direction. The input and output signal transmission lines are symmetrically arranged with respect to a second midline. The second midline is a midline of the CPW plane in the transverse direction. The input signal transmission line is separated from the output signal transmission line by a central transverse gap. The middle signal region is composed of the input and output signal transmission lines and the central transverse gap. The first CPW resonator is separated from the second CPW resonator by a first transverse gap. The first transverse gap is aligned with the second midline. In the transverse direction, the first and second CPW resonators are separated from the middle signal region by a first longitudinal gap and from the first ground metal plate by a second longitudinal gap. The third CPW resonator is separated from the fourth CPW resonator by a second transverse gap. The second transverse gap is aligned with the second midline. In the transverse direction, the third and fourth CPW resonators are separated from the middle signal region by a third longitudinal gap and from the second ground metal plate by a fourth longitudinal gap. The first and third CPW resonators are symmetrically arranged with respect to the first midline. The second and fourth CPW resonators are symmetrically arranged with respect to the first midline. The first and second CPW resonators are symmetrically arranged with respect to the second midline. The third and fourth CPW resonators are arranged symmetrically metrical about the second midline.

Additionally or optionally, in the longitudinal direction, a total length of the first and second CPW resonators and the first transverse gap is greater than a length of the central transverse gap but less than a length of the CPW plane. In the longitudinal direction, a total length of the third and fourth CPW resonators and the second transverse gap is greater than the length of the central transverse gap but less than the length of the CPW plane.

Additionally or optionally, first, second, third and fourth T-slots are embedded into the first, second, third and fourth CPW resonators, respectively. The first and third T-slots are symmetrically arranged with respect to the first midline. The second and fourth T-slots are symmetrically arranged with respect to the first midline. The first and second T-slots are symmetrically arranged with respect to the second midline. The third and fourth T-slots are symmetrically arranged with respect to the second midline. Each T-slot of the first, second, third and fourth T-slots embedded into its respective CPW resonator has a height equal to a thickness of the respective CPW resonator. Each T-slot comprises a longitudinal slot extending along a longitudinal midline of the respective CPW resonator and a transverse slot extending from a midpoint of a long side of the longitudinal slot to a midpoint of a long side, oriented away from the middle signal region, of the respective CPW resonator. Each T-slot shapes the respective CPW resonator into a rectangular ring comprising a notch positioned at a midpoint of a long side of the rectangular ring, and the notch is oriented away from the middle signal region.

Additionally or optionally, each T-slot is symmetric with respect to a transverse midline of the respective CPW resonator.

Additionally or optionally, a transmission zero in an upper stopband is achievable by the first, second, third and fourth T-slots.

Additionally or optionally, the CPW-based mmWave bandpass filter further comprises a first T-stub positioned in the second longitudinal gap and connected to the first ground metal plate and a second T-stub positioned in the fourth longitudinal gap and connected to the second ground metal plate. In the transverse direction, the first T-stub is separated from the first and second CPW resonators by a fifth longitudinal gap. In the transverse direction, the second T-stub is separated from the third and fourth CPW resonators by a sixth longitudinal gap. The first and second T-stubs are symmetrically arranged with respect to the first midline. Each T-stub of the first and second T-stubs comprises a longitudinal section and a transverse section. The transverse section of the first T-stub extends from a midpoint of a long side, oriented closer to the first and second CPW resonators, of the first ground metal plate to a midpoint of a long side of the longitudinal section of the first T-stub. The transverse section of the second T-stub extends from a midpoint of a long side, oriented closer to the third and fourth CPW resonators, of the second ground metal plate to a midpoint of a long side of the longitudinal section of the second T-stub.

Additionally or optionally, in the longitudinal direction, a length of the longitudinal section of the first T-stub is greater than a total length of the first and second CPW resonators and the first transverse gap but less than a length of the CPW plane. In the longitudinal direction, a length of the longitudinal section of the second T-stub is greater than a total length of the third and fourth CPW resonators and the second transverse gap but less than the length of the CPW plane.

Additionally or optionally, each T-stub is symmetric with respect to the second midline.

Additionally or optionally, two transmission zeros in a lower stopband are achievable by the first and second T-stubs.

Additionally or optionally, the CPW-based mmWave bandpass filter further comprises a cross-shaped dual-mode resonator. The cross-shaped dual-mode resonator comprises a longitudinal arm positioned in the central transverse gap and extending along the first midline and a transverse arm extending along the second midline. The longitudinal arm is separated from the input signal transmission line by a third transverse gap and from the output signal transmission line by a fourth transverse gap. The longitudinal arm is symmetric with respect to the first and second midlines. The third and fourth transverse gaps are each symmetric with respect to the first midline. The third and fourth transverse gaps are arranged symmetric with respect to the second midline. The transverse arm is separated from the first ground metal plate by a seventh longitudinal gap and from the second ground metal plate by an eighth longitudinal gap. The transverse arm is symmetric with respect to the first and second midlines. The seventh and eighth longitudinal gaps are each symmetric with respect to the second midline. The seventh and eighth longitudinal gaps are symmetrically arranged with respect to the first midline. The seventh longitudinal gap extends deep into interior of the first ground metal plate, such that a first inward recess is formed near a midpoint of a long side, oriented closer to the transverse arm, of the first ground metal plate. The eighth longitudinal gap extends deep into interior of the second ground metal plate, such that a second inward recess is formed near a midpoint of a long side, oriented closer to the transverse arm, of the second ground metal plate.

Additionally or optionally, first, second, third and fourth I-slots are embedded into the first, second, third and fourth CPW resonators, respectively. The first and third I-slots are symmetrically arranged with respect to the first midline. The second and fourth I-slots are symmetrically arranged with respect to the first midline. The first and second I-slots are symmetrically arranged with respect to the second midline. The third and fourth I-slots are symmetrically arranged with respect to the second midline. Each I-slot of the first, second, third and fourth I-slots embedded into its respective CPW resonator has a height equal to a thickness of the respective CPW resonator. Each I-slot comprises a single transverse slot extending from a midpoint of a first long side, oriented away from the middle signal region, of the respective CPW resonator, towards a midpoint of a second long side, oriented closer to the middle signal region, of the respective CPW resonator without extending through the second long side. Each I-slot shapes the respective CPW resonator into a rectangular strip comprising a notch positioned at a midpoint of a long side of the rectangular strip. The notch is oriented away from the middle signal region.

Additionally or optionally, bandwidth of the filter is increased by adding the cross-shaped dual-mode resonator.

Additionally or optionally, the substrate is a lithium niobate (LiNbO3) substrate.

Other example embodiments are discussed herein.

### BRIEF DESCRIPTION OF THE DRAWINGS

Embodiments of the disclosure will now be described, by way of example only, with reference to the accompanying drawings in which:

FIG. 1 illustrates an RF system comprising mmWave filters to divide frequency bands according to a certain embodiment of the present disclosure.

FIG. 2 illustrates a side view of a CPW-based mmWave bandpass filter according to a certain embodiment of the present disclosure.

FIG. 3A illustrates a top view of a CPW-based mmWave bandpass filter according to a certain embodiment of the present disclosure.

FIG. 3B illustrates the simulated S-parameters of the filter in FIG. 3A.

FIG. 4A illustrates a top view of a CPW-based mmWave bandpass filter according to a certain embodiment of the present disclosure.

FIG. 4B illustrates a top view of the third T-slot in FIG. 4A.

FIG. 4C illustrates the simulated S-parameters of the filter in FIG. 4A.

FIG. 5A illustrates a top view of a CPW-based mmWave bandpass filter according to a certain embodiment of the present disclosure.

FIG. 5B illustrates a stereogram of the filter in FIG. 5A.

FIG. 5C illustrates the notations for dimensions of each element of the filter in FIG. 5A.

FIG. 5D illustrates the simulation results of frequency response varying with a length (L₃) of the longitudinal slot of each T-slot in a longitudinal direction in the filter of FIG. 5A.

FIG. 5E illustrates the simulation results of center frequency varying with a length (L₂) of each CPW resonator in the longitudinal direction in the filter of FIG. 5A.

FIG. 5F illustrates the simulation results of bandwidth of a passband varying with a width (g₂) of the first and second transverse gaps in the longitudinal direction in the filter of FIG. 5A.

FIG. 5G illustrates the simulation results of the frequency response with and without the presence of T-stubs in the filter of FIG. 5A.

FIG. 5H illustrates the simulation results of the frequencies of two TZs in a lower stopband varying with a length (L₄) of the longitudinal section of each T-stub in the longitudinal direction in the filter of FIG. 5A.

FIG. 5I illustrates the simulated and tested S-parameters of the filter in FIG. 5A when applying the proposed dimensions.

FIG. 5J illustrates the simulated and tested group delay of the filter in FIG. 5A when applying the proposed dimensions.

FIG. 6A illustrates a top view of a CPW-based mmWave bandpass filter according to a certain embodiment of the present disclosure.

FIG. 6B illustrates a top view of the third I-slot in FIG. 6A.

FIG. 6C illustrates the simulated S-parameters of the filter in FIG. 6A.

In the drawings, similar reference numbers are used for similar elements to aid comprehension.

### DETAILED DESCRIPTION

The present disclosure will now be described with reference to the following examples which should be considered in all respects as illustrative and non-restrictive. In the Figures, corresponding features within the same embodiment or common to different embodiments have been given the same or similar reference numerals.

Throughout the description and the claims, the words “comprise”, “comprising”, and the like are to be construed in an inclusive sense as opposed to an exclusive or exhaustive sense; that is to say, in the sense of “comprising, but not limited to”.

Furthermore, as used herein and unless otherwise specified, the use of the ordinal adjectives “first”, “second”, etc., to describe a common object, merely indicate that different instances of like objects are being referred to, and are not intended to imply that the objects so described must be in a given sequence, either temporally, spatially, in ranking, or in any other manner.

### A. Technical Terms and Notations

The following terms and notations are used herein in the specification and appended claims.

“Microwave”, “Radio Frequency (RF)”, “Millimeter-Wave (mmWave)”: Microwave is a form of electromagnetic (EM) radiation with wavelength ranges from about one meter to one millimeter, corresponding to frequencies between 300 MHz and 300 GHz, broadly construed. A more common definition in RF engineering is the range between 20 k and 300 GHz (wavelengths between 1 mm and 15 km). mmWave is a type of EM wave with a wavelength ranging from 1 mm to 10 mm and a frequency between 30 GHz and 300 GHz.

“Electromagnetic Filter (EM filter)”: An EM filter is a device or circuit designed to selectively pass or block specific frequency components of an EM signal. It is used to filter out unwanted frequencies while allowing desired frequencies to pass through. The manufacturing technologies commonly used for RF filters include monolithic microwave integrated circuit (MMIC), low temperature co-fired ceramic (LTCC) and printed circuit board (PCB). Various fabrication process technologies are used, including silicon microelectromechanical systems (Si MEMS), gallium arsenide (GaAs), GaAs MEMS, silicon benzocyclobutene (Si BCB), silicon germanium (SiGe), integrated passive device (IPD), liquid crystal polymer (LCP) and complementary metal-oxide-semiconductor (CMOS).

“Bipolar CMOS (Bi-CMOS)” is a semiconductor technology that integrates two semiconductor technologies, those of the bipolar junction transistor (BJT) and the CMOS logic gate, into a single integrated circuit (IC).

“Coplanar Waveguide (CPW)”: CPW is a type of electrical planar transmission line which can be fabricated using PCB technology, and is used to convey microwave-frequency signals. It is a type of transmission line that allows for the propagation of high-frequency signals with minimal loss and interference. CPW consists of a central signal conductor (strip) flanked by two ground planes on the same plane. All three conductors are on the same side of the substrate, and hence are coplanar. The signal conductor and ground planes are separated by a dielectric substrate.

“Substrate Integrated Waveguide (SIW)”: SIW is a modem waveguide technology that combines the advantages of traditional rectangular waveguides and planar transmission lines, such as microstrips or CPWs. It is implemented within a dielectric substrate, making it compatible with standard PCB fabrication processes. SIW structures are widely used in microwave and mmWave applications due to their high performance, compact size, and ease of integration.

“Silicon-on-Insulator (SOI)”: SOI is a semiconductor manufacturing technology that involves creating a layered structure consisting of a thin layer of silicon on top of an insulating layer, typically silicon dioxide (SiO₂), which is then placed on a silicon substrate. This unique structure provides significant advantages over traditional bulk silicon technology, particularly in terms of performance, power efficiency, and integration capabilities. SOI is widely used in the fabrication of ICs and MEMS.

“Lithium Niobate (LiNbO₃)”: LiNbO₃, or LN, is a widely used as substrate material in photonics, acoustooptics, and microwave applications due to its excellent electro-optic, piezoelectric, and nonlinear optical properties. After a crystal is grown, it is sliced into wafers of different orientations relative to crystal axes. Common orientations are Z-cut, X-cut, Y-cut, and cuts with rotated angles of the previous axes.

“Piezoelectric Effect”: Piezoelectric effect or piezoelectricity is a property of certain materials that allows them to generate an electric charge in response to applied mechanical stress (direct piezoelectric effect) or to undergo mechanical deformation in response to an applied electric field (inverse piezoelectric effect). This effect is reversible and is observed in materials with a non-centrosymmetric crystal structure, such as quartz, LiNbO₃, and lead zirconate titanate (PZT).

“Acoustic Filter”: An acoustic filter is a device that uses acoustic waves to selectively pass or block specific frequency components of a signal. These filters are widely used in telecommunications, signal processing, and sensing applications. Acoustic filters are typically implemented using piezoelectric materials, such as quartz, LiNbO₃, or aluminum nitride (AlN), which convert electrical signals into mechanical vibrations (acoustic waves) and vice versa. There are several types of acoustic filters: Surface Acoustic Wave (SAW) Filters, which use acoustic waves that propagate along the surface of a piezoelectric substrate; Bulk Acoustic Wave (BAW) Filters, which use acoustic waves that propagate through the bulk of a piezoelectric material and can provide higher frequencies compared to SAW filters.

“Hybrid Microwave Filter”: Hybrid microwave filters have been innovatively developed through the co-design of EM and acoustic filters. The hybrid filters achieve broadband performance while retaining the advantages of compact size and high quality factor inherent in the acoustic domain.

“Passband”, “Upper Stopband”, “Lower Stopband”: A passband is the range of frequencies or wavelengths that can pass through a filter. A stopband is a range of frequencies in which the filter significantly reduces or suppresses the signal. An upper stopband refers to the frequency range above the passband where the filter attenuates signals. The lower stopband refers to the frequency range below the passband where the filter attenuates signals.

“Center Frequency”: A center frequency refers to the middle frequency of a passband or a resonant frequency range in a filter, oscillator, or any frequency-selective system. Mathematically, the center frequency (f_{c}) can be calculated as the geometric mean of the lower (f₁) and upper (f₂) cutoff frequencies in a bandpass filter:

$${f}_{c} = \sqrt{{f}_{1} \cdot {f}_{2}}$$

“Fractional Bandwidth (FBW)”, “3-dB FBW”: FBW is a dimensionless measure used to describe the bandwidth of a system or component relative to its center frequency. It is expressed as a ratio or percentage and is particularly useful for comparing the bandwidth performance of systems operating at different center frequencies. FBW provides insight into the relative width of the frequency range over which the system operates effectively. A 3-dB FBW (or 3-dB relative bandwidth) is a measure used to describe the width of a frequency range in a filter or resonant system. The term “3-dB” refers to the point where the power of the signal is reduced to half of its maximum value, as a 3-dB drop corresponds to a 50% reduction in power. Mathematically, FBW is calculated as:

$$FBW = \frac{{f}_{2} - {f}_{1}}{{f}_{c}} \times 100 \%$$

wherein f₁ and f₂ are the lower and upper cutoff frequencies respectively.

“Insertion Loss (IL)”: IL is a key performance metric used to describe the reduction in signal power that occurs when a component, such as a filter, is inserted into a transmission line or system. It is typically measured in dB and represents the loss of signal strength due to the introduction of the component. Mathematically, the IL is expressed as:

$$IL = 10 \cdot {log}_{10} ( \frac{{P}_{in}}{{P}_{out}} ) ,$$

where Pᵢₙ is input power and Pₒᵤₜ is output power.

“Stopband Suppression Level”: Stop suppression level refers to the degree of attenuation or reduction of signals within the stopband of a filter or frequency-selective system. It quantifies how effectively the filter blocks or suppresses unwanted frequencies outside its passband, typically measured in dB.

“Return Loss”: Return loss quantifies the amount of signal power reflected back to the source due to impedance mismatches at the filter's input or output ports. It is typically expressed in decibels (dB) and indicates the ratio of the power of the incoming signal to the power of the reflected signal. A higher return loss value (closer to infinity) indicates better performance.

$$Return Loss ( dB ) = 10 \cdot {log}_{10} ( \frac{{P}_{incident}}{{P}_{reflected}} )$$

where P_{incident} indicates the power of the incident signal, while P_{reflected} refers to the power of the reflected signal.

“Transmission Zero (TZ)”: A TZ is a frequency at which the transfer function of a filter or a network exhibits a sharp drop in signal transmission, resulting in near-complete attenuation of the signal. In other words, it is a frequency point where the output signal power is significantly reduced, ideally to zero, indicating that the filter effectively blocks or rejects signals at that specific frequency.

“Group Delay”: Group delay is a measure of the time delay experienced by different frequency components of a signal as they pass through a system, such as a filter, amplifier, or communication channel. It is defined as the negative derivative of the phase response with respect to angular frequency and is typically measured in seconds. Group delay provides insight into the phase distortion characteristics of a system, which is critical for maintaining signal integrity. Mathematically, group delay (τ_{g}) is expressed as:

$${τ}_{g} = - \frac{d φ ( w )}{dw}$$

where φ(w) is phase response of the system as a function of angular frequency (w).

“Roll-off Rate”: Roll-off rate refers to a rate at which the frequency response of a filter or system decreases outside its passband. It is a measure of how quickly the signal attenuation increases as the frequency moves away from the cutoff frequency, typically expressed in dB per decade (dB/decade) or dB per octave (dB/octave). The roll-off rate is a critical parameter in filter design, as it determines the filter's ability to distinguish between desired signals within the passband and unwanted signals in the stopband.

“Scattering Parameters (S-parameters)”: S-parameters are a fundamental tool used in the simulation and analysis of filters, particularly in high-frequency and microwave engineering. They describe how electrical signals propagate through a network, such as a filter, by quantifying the relationship between the incident and reflected waves at each port of the device. S-parameters are a set of complex numbers that represent the amplitude and phase of the output signals relative to the input signals. For a two-port network (e.g., a filter), the S-parameters are typically represented as a matrix:

$$[ \begin{matrix}{S}_{11} & {S}_{12} \\ {S}_{21} & {S}_{22}\end{matrix} ]$$

S₁₁ is the reflection coefficient at the input port. S₁₂ is the transmission coefficient from the output to the input port. S₂₁ is the transmission coefficient from the input port to the output port. S₂₂ is the reflection coefficient at the output port. S-parameters are often plotted as magnitude (in dB) and phase (in degrees) versus frequency. Common plots include S₂₁ for visualizing the filter's frequency response (passband and stopband) and S₁₁ for assessing input matching and reflection characteristics.

### B. Research Objectives

The wireless communication terminals demand the filter chips with low IL over the passband, high stopband suppression level, high roll-off rate, and small size. Acoustic filters are significantly smaller than traditional EM filters, making them ideal for integration into miniaturized devices such as smartphones, wearables, and Internet of Things (IoT) devices. Their small footprint is achieved by leveraging the slow propagation speed of acoustic waves, which allows for shorter wavelengths at a given frequency. From the 2G to 5G, sub-6 GHz wireless communication terminals, SAW and BAW filter chips are applied to select signals. However, the SAW and BAW filter chips suffer from narrow bandwidth and the frequency limit is generally around 6 GHz. The mmWave frequency band above 6 GHz offers significantly broader application potential, since it has large bandwidth, which can improve the communication capacity and data rate. Though the frequency limit of the SAW and BAW filter chips can be increased with approaches such as shrinking the size of the filters or using the high-order mode, the issues of narrow bandwidth and large IL over the passband exist. Therefore, the EM mmWave filter chips will be the main solutions for the 5G-6G wireless communication terminals.

The mmWave filters using the PCB technology have been extensively researched. L. Zhu et al. proposed a mmWave SIW bandpass filter using the PCB technology in 2023 [1]. The center frequency is 25.88 GHz with the FBW of 4.48%, the minimum IL is 4.36 dB, and the size of 0.84λ₀×0.53λ₀. To achieve size reduction, the LTCC technology and IPD technology have been applied to design the mmWave filters. Y. Li et al. proposed a mmWave SIW bandpass filter using the LTCC technology in 2017 [2]. The center frequency is 174 GHz with the FBW of 13.8%, and the measured IL at the center frequency is 1.9 dB. In 2019, M. G. Bautista et al. proposed a mmWave bandpass filter using 0.13 um Bi-CMOS technology [3]. The center frequency is 29 GHz with the FBW of 26.7% and the minimum IL of 3.5 dB. In 2021, G. Shen et al. proposed a MMIC bandpass filter for 5G mmWave applications [4]. The center frequency is 28.4 GHz with the FBW of 10.6% and the minimum IL of 1.8 dB. In 2021, Z. Ge et al. proposed a mmWave wideband bandpass filter in CMOS technology [5]. The center frequency is 34.5 GHz with the FBW of 61.2% and the minimum IL of 1.6 dB. L. Gao et al. proposed a mmWave bandpass filter using 45-nm CMOS SOI in 2021 [6]. The center frequency is 33 GHz with the FBW of 66.7% and the minimum IL is 1.5 dB.

To improve the stopband suppression level and roll-off rate, the hybrid microwave filters have been presented. In 2020, H. Wu et al. proposed a hybrid wideband bandpass filter integrated with the FBAR to realize high roll-off rate [7]. The center frequency is 2.14 GHz with the FBW of 24.9% and the minimum IL is 1.87 dB. In 2020, R. Zhang et al. proposed a hybrid bandpass filter integrated with SAW resonators [8]. The center frequency is 418 MHz with the FBW of 0.03% and the minimum IL is 4.3 dB. In 2020, T. Cai et al. proposed a hybrid dual-band bandpass filter integrated with SAW resonators [9]. The center frequency for the first passband is 869 MHz with the FBW of 0.37% and the minimum IL is 0.89 dB. The center frequency for the second passband is 916 MHz with the FBW of 0.25% and the minimum IL is 1.57 dB. Till now, the hybrid filters have the working frequencies at sub-6 GHz and the hybrid mmWave filters are not available.

In conclusion, the mmWave filter chips with low IL over the passband, high stopband suppression level, high roll-off rate, and small size for the wireless communication terminals have remained challenging and not available worldwide. The present application proposed a CPW-based mmWave bandpass filter having advantages of wide bandwidth, low IL over the passband, high stopband suppression level, and small size.

The inventors aim to design narrowband and wideband mmWave bandpass filter chips achieving center frequencies within the range of 30-60 GHz. The 3-dB FBW of the narrowband filter chip will be no more than 30%, while the 3-dB FBW of the wideband filter chip will be no less than 50%. The minimum IL over the passband will be less than 1.5 dB, while the minimum stopband suppression level will be greater than 20 dB. The area of the narrowband and the wideband filter chips will be less than 4 mm² and 6 mm², respectively.

### C. Details of Embodiments of Present Disclosure

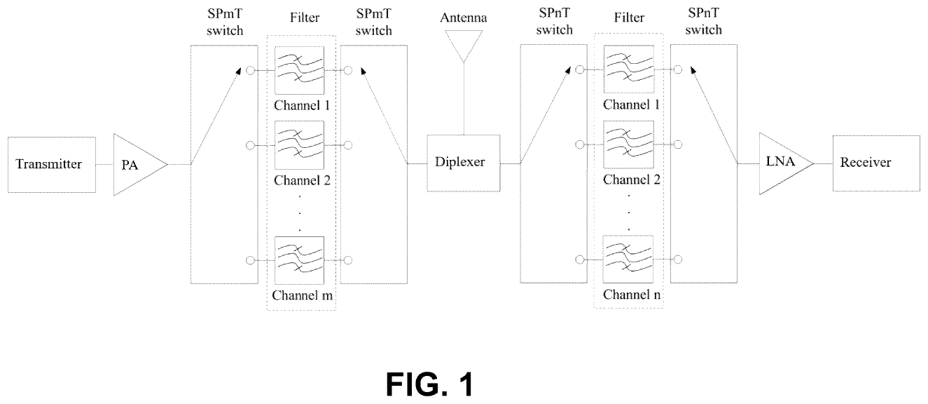

FIG. 1 illustrates an RF system comprising mmWave filters to divide frequency bands according to a certain embodiment of the present disclosure. To meet requirements of 5G-6G wireless communication systems, the mmWave filters are key components to realize frequency selectivity in RF systems. FIG. 1 shows that a large number of mmWave filters to divide frequency bands are in demand.

C.1 CPW-Based mmWave Filter with Four Half-Wavelength Resonators

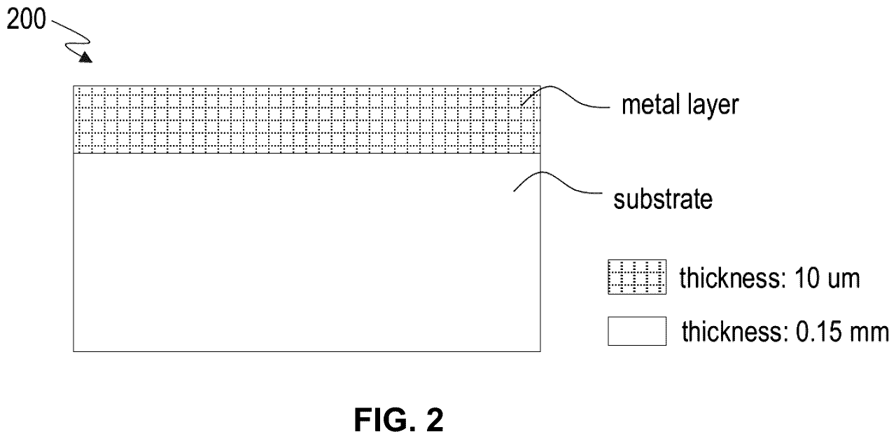

FIG. 2 illustrates a side view of a CPW-based mmWave bandpass filter 200 according to a certain embodiment of the present disclosure. The CPW-based mmWave bandpass filter is designed using a LN piezoelectric substrate. LN, an anisotropic piezoelectric material, exhibits the relative permittivity, as shown in the following matrix expression (1), when cut at 128° Y. LN crystals are characterized by their low cost, small loss tangent, and high permittivity. The high permittivity of the LN substrate facilitates the reduction of the filter's size, while the low loss tangent is beneficial to realize high selectivity. Micro-nano fabrication technology enables high-precision processing of the mmWave bandpass filter 200. Other materials of substrate can be applied, such as lithium tantalate (LiTaO₃ or LT). The selected materials of substrate should have a high permittivity. The employed LN substrate has a thickness of about 0.15 mm. The thickness of LN substrate is critical to the LN-based mmWave filter, thus the tolerance of LN thickness needs to be small enough. A surface metal layer is disposed above the LN substrate in areas requiring lines to facilitate signal transmission and ground arrangement. In a preferred embodiment, the metal layer can be a copper (Cu) layer with a thickness of 10 μm. In FIG. 2, the Cu layer is represented by shaded grids, while the LN substrate is depicted in white. These legends are consistently applicable to all subsequent figures. The dimensions in all figures are schematic only and do not represent actual sizes or relative proportions of each element.

$$[ \begin{matrix}45 & 0 & 0 \\ 0 & 38.9 & 0 \\ 0 & 0 & 35\end{matrix} ]$$

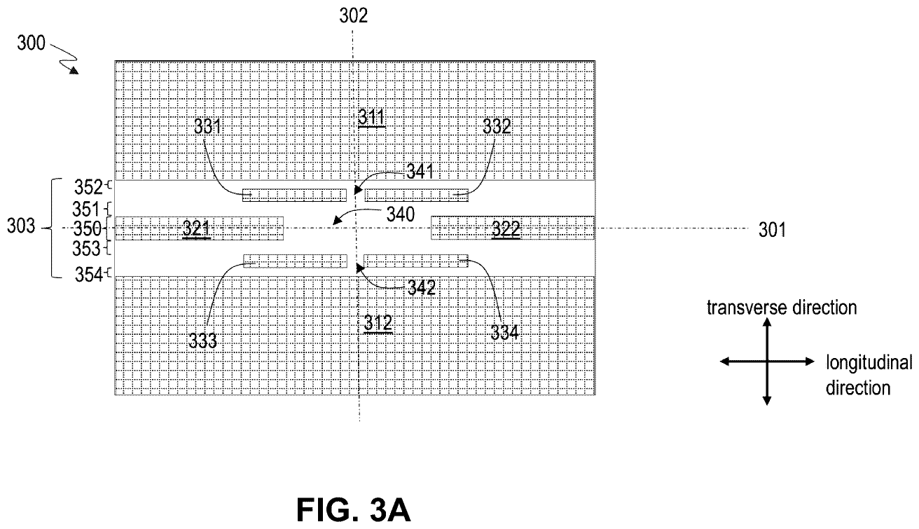

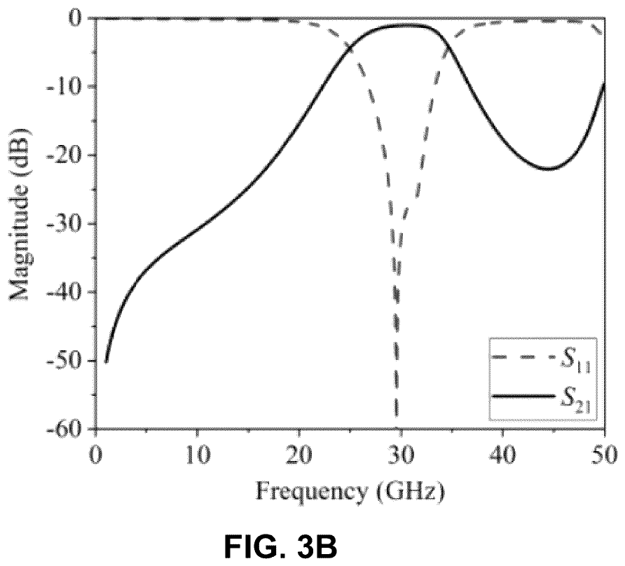

FIG. 3A illustrates a top view of a CPW-based mmWave bandpass filter 300 according to a certain embodiment of the present disclosure. From the top view, a horizontal cross-section of the LN substrate is approximately rectangular in shape. The Cu layer will be disposed on the LN substrate. The plane where the Cu layer resides is defined as a CPW plane. In the context of the specification and claims, the direction along a long side of the rectangular CPW plane is defined as a longitudinal direction, and the direction along a short side of the rectangular CPW plane is defined as a transverse direction. For ease of description, a midline along the longitudinal direction of the rectangular CPW plane is defined as a first midline 301, while a midline along the transverse direction of the rectangular CPW plane is defined as a second midline 302. First and second ground metal plates 311, 312 are each coupled to ground and disposed on the rectangular CPW plane. In the longitudinal direction, the first and second ground metal plates 311, 312 extend continuously from one end to the other end of the CPW plane along the longitudinal direction. In the transverse direction, the first and second ground metal plates 311, 312 are respectively positioned on the two opposite sides of the CPW plane along the transverse direction, leaving a signal region 303 between the first and second ground metal plates 311, 312. The first and second ground metal plates 311, 312 are each symmetric with respect to the second midline 302 and are symmetrically arranged with respect to the first midline 301. In a certain embodiment, both the first and second ground metal plates 311, 312 are rectangular in shape from the top view. In the present disclosure, both the thickness and height directions are perpendicular to the CPW plane.

An input signal transmission line 321 and an output signal transmission line 322 are respectively positioned at the two ends of the signal region 303 in the longitudinal direction and aligned with the first midline 301. The input and output signal transmission lines 321, 322 are each symmetric with respect to the first midline 301 and are symmetrically arranged with respect to the second midline 302. The input signal transmission line 321 is separated from the output signal transmission line 322 by a central transverse gap 340. A middle signal region 350 is composed of the input and output signal transmission lines 321, 322 and the central transverse gap 340. Signals propagate from a CPW input port consisting of the input signal transmission line 321 and the first and second ground metal plates 311, 312 towards a CPW output port consisting of the output signal transmission line 322 and the first and second ground metal plates 311, 312. For all the embodiments of the present disclosures, the input impedance of the CPW input port and the output impedance of the CPW output port are 50Ω, respectively. In a certain embodiment, both the input and output signal transmission lines 321, 322 are rectangular in shape from the top view.

Four half-wavelength CPW resonators are designed between the middle signal region 350 and the first and second ground metal plates 311, 312. Specifically, first and second CPW resonators 331, 332 are each longitudinally arranged between the first ground metal plate 311 and the middle signal region 350. Third and fourth CPW resonators 333, 334 are each longitudinally arranged between the second ground metal plate 312 and the middle signal region 350. The first CPW resonator 331 is separated from the second CPW resonator 332 by a first transverse gap 341. The third CPW resonator 333 is separated from the fourth CPW resonator 334 by a second transverse gap 342. The first and second transverse gaps 341, 342 each extend along the second midline 302 in the transverse direction. The first and third CPW resonators 331, 333 are symmetrically arranged with respect to the first midline 301, and the second and fourth CPW resonators 332, 334 are symmetrically arranged with respect to the first midline 301. The first and second CPW resonators 331, 332 are symmetrically arranged with respect to the second midline 302, and the third and fourth CPW resonators 333, 334 are arranged symmetrically metrical about the second midline 302. In a certain embodiment, the four CPW resonators 331, 332, 333, 334 are rectangular in shape from the top view.

In the transverse direction, the first and second CPW resonators 331, 332 are separated from the middle signal region 350 by a first longitudinal gap 351 and from the first ground metal plate 311 by a second longitudinal gap 352. In the transverse direction, the third and fourth CPW resonators 333, 334 are separated from the middle signal region 350 by a third longitudinal gap 353 and from the second ground metal plate 312 by a fourth longitudinal gap 354.

FIG. 3B illustrates the simulated S-parameters of the filter 300. The center frequency is 30 GHz and the FBW is 27%. The minimum passband IL is 1.04 dB, while the return loss at 30 GHz is 32 dB. However, suppression at the upper stopband is low and improvements are required.

C.2 CPW-Based mmWave Filter Comprising Resonators with Slots

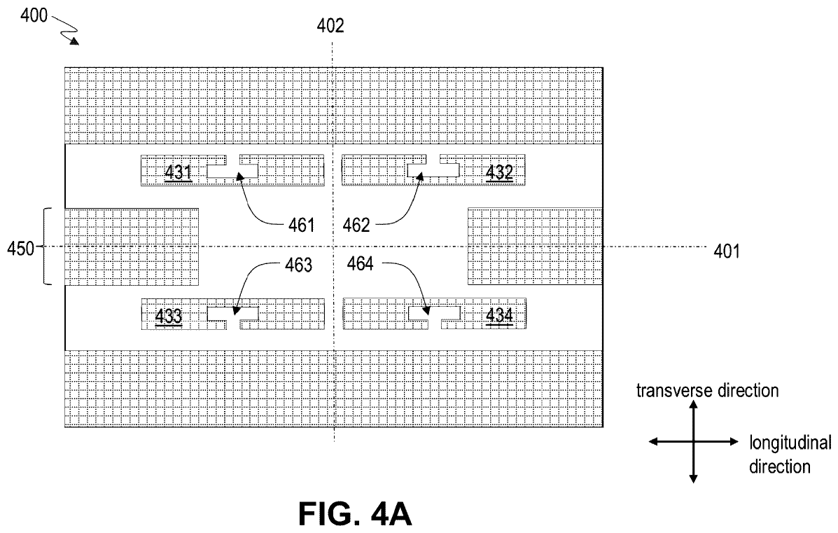

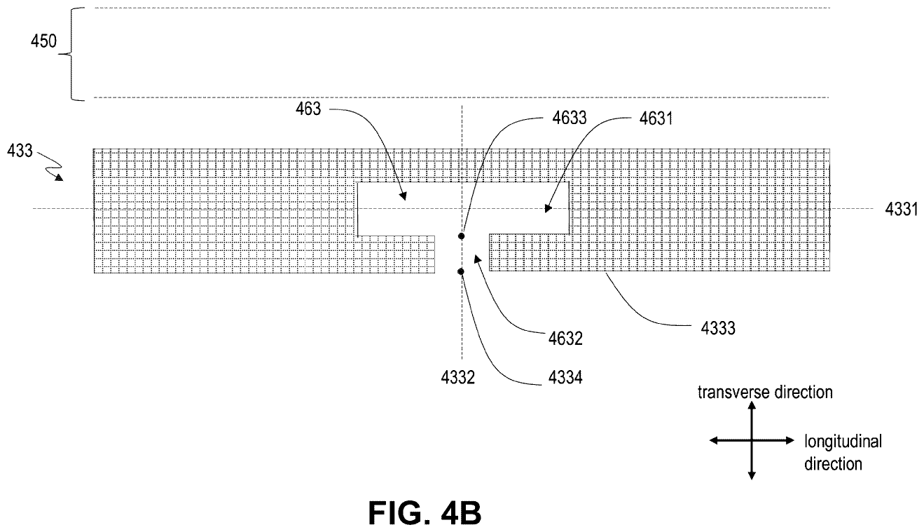

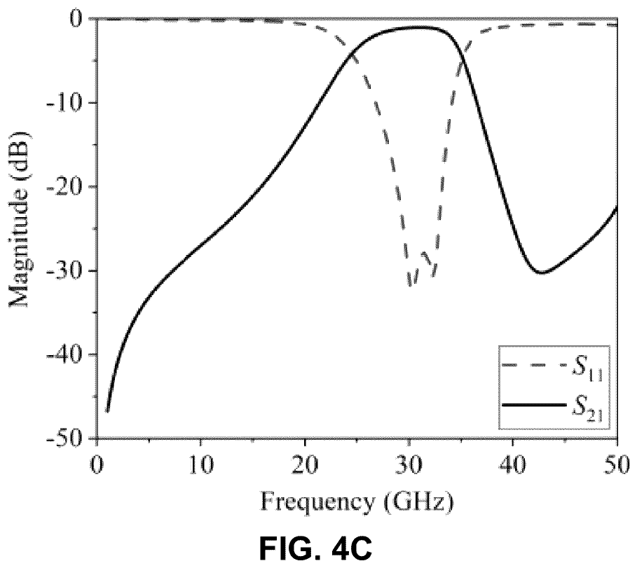

The reason for the low suppression at the upper stopband is caused by a parasitic passband. The parasitic passband can be suppressed by integrating a T-slot in each half-wavelength resonator. FIG. 4A illustrates a top view of a CPW-based mmWave bandpass filter 400 according to a certain embodiment of the present disclosure. Specifically, first, second, third and fourth T-slots 461, 462, 463, 464 are embedded into the first, second, third and fourth CPW resonators 431, 432, 433, 434, respectively. The first and third T-slots 461, 463 are symmetrically arranged with respect to the first midline 401, the second and fourth T-slots 462, 464 are symmetrically arranged with respect to the first midline 401, the first and second T-slots 461, 462 are symmetrically arranged with respect to the second midline 402, and the third and fourth T-slots 463, 464 are symmetrically arranged with respect to the second midline 402. A height of each T-slot 461, 462, 463, 464 is equal to a thickness of its respective CPW resonator 431, 432, 433, 434.

Each T-slot, taking the third T-slot 463 as an example as shown in FIG. 4B, comprises a longitudinal slot 4631 and a transverse slot 4632. The longitudinal slot 4631 extends along a longitudinal midline 4331 of the third CPW resonator 433. In an alternative embodiment, the longitudinal slot 4631 need not be perfectly aligned with the longitudinal midline 4331 of the third CPW resonator 433. The transverse slot 4632 extends from a midpoint 4633 of a long side of the longitudinal slot 4631 to a midpoint 4334 of a long side 4333, oriented away from the middle signal region 450, of the third CPW resonator 433 along a transverse midline 4332 of the third CPW resonator 433. In this way, the third T-slot 463 shapes the third CPW resonator 433 into a rectangular ring comprising a notch positioned at the midpoint 4334 of the long side 4333 of the rectangular ring. The long side of the longitudinal slot 4631 can be either of its two long sides. The notch is oriented away from the middle signal region 450. Though the third T-slot 463 is illustrated as an example, the first, second and fourth T-slots 461, 462, 464 have similar configurations.

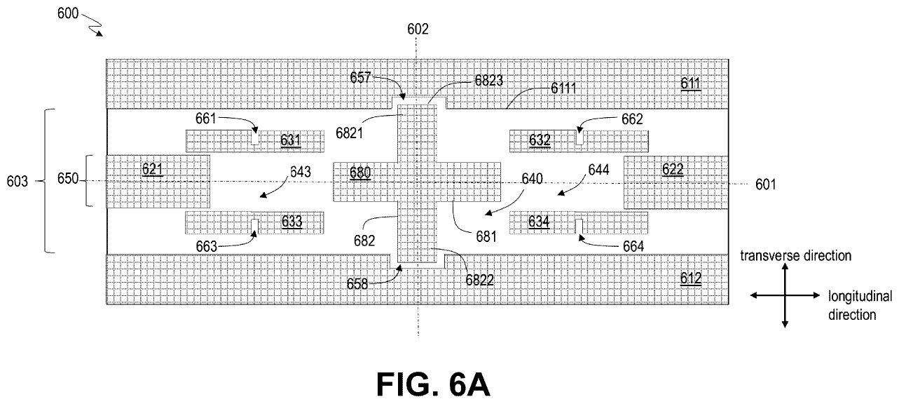

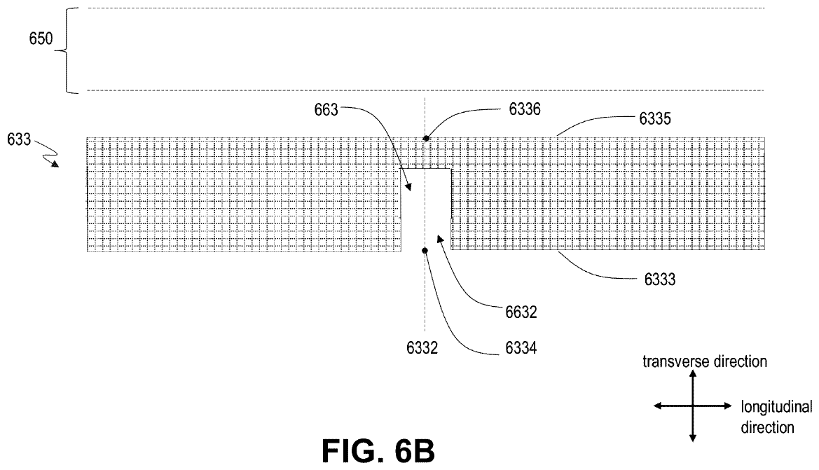

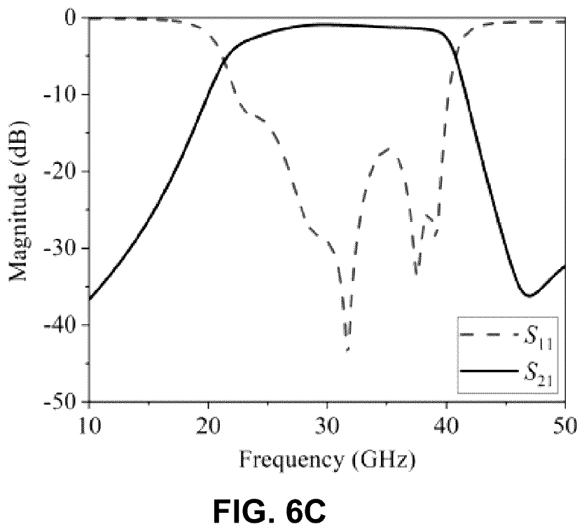

Each T-slot 461, 462, 463, 464 is equivalent to a capacitor and an inductor connected in parallel, which can reduce the size of the filter and create a TZ in the upper stopband, as shown in FIG. 4C, which illustrates the simulated S-parameters of the filter 400. The center frequency is 30 GHz and the FBW is 29.9%. The minimum passband IL is 1.03 dB, while the return loss at 30 GHz is 30 dB. The suppression at the upper stopband has been improved to be more than 20 dB. The total size is 1.78 mm×1.65 mm. Other slot shapes of reasonable configurations are within the scope of the present disclosure, for example, the I-slots as shown in FIG. 6A, which will be discussed later.

C.3 CPW-Based mmWave Filter Comprising Resonators and T-Stubs

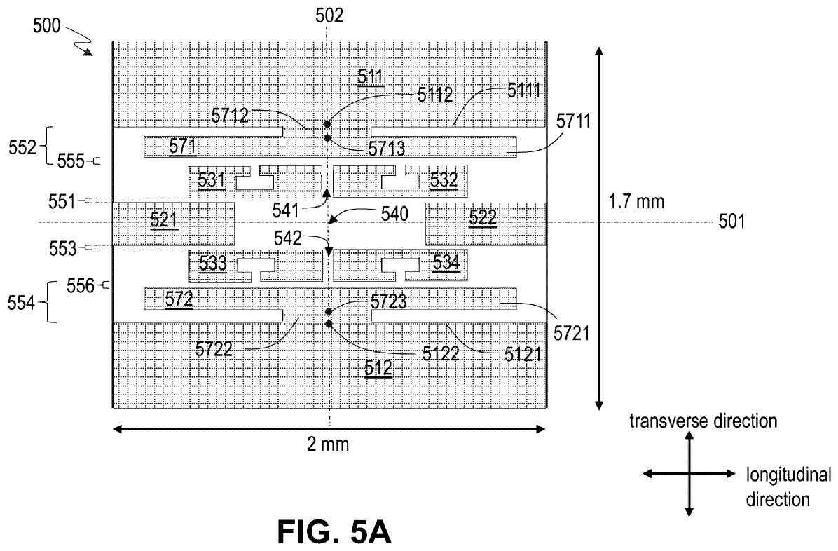

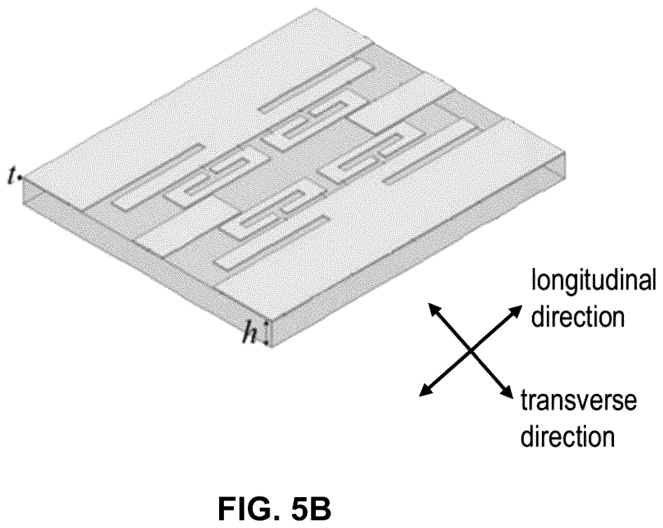

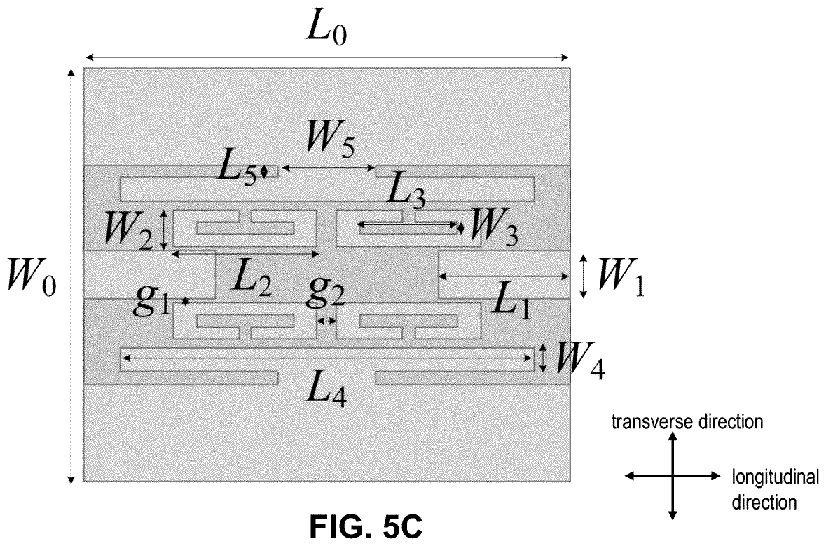

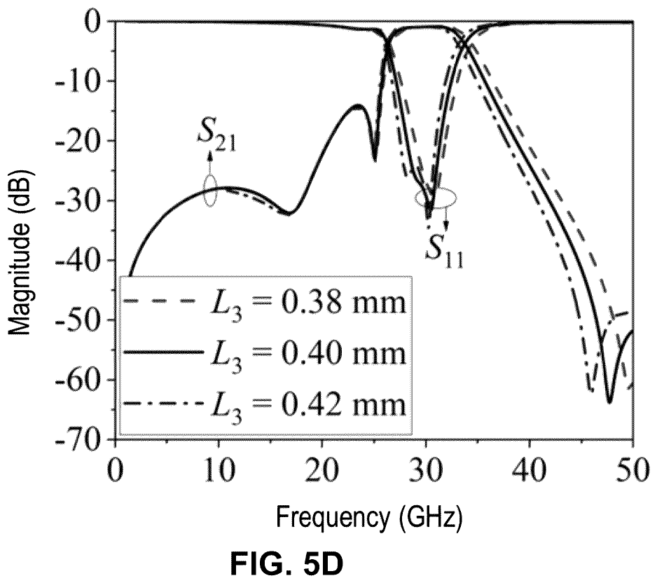

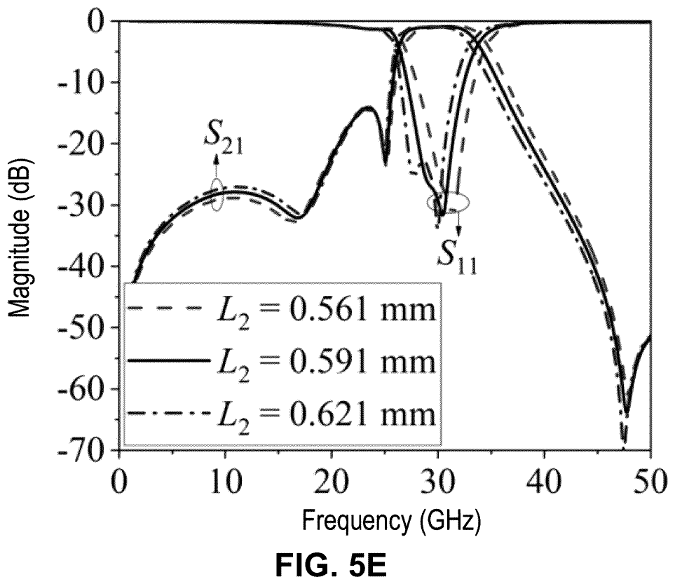

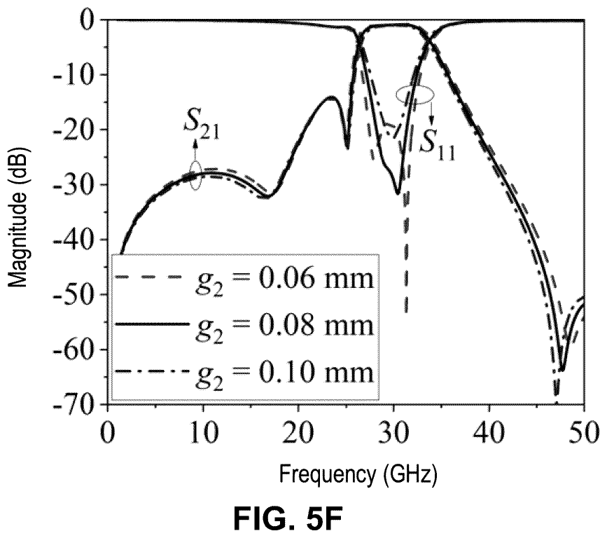

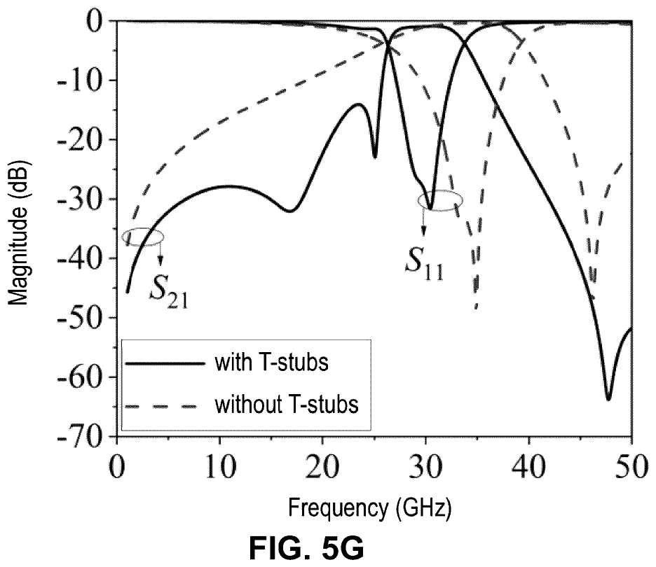

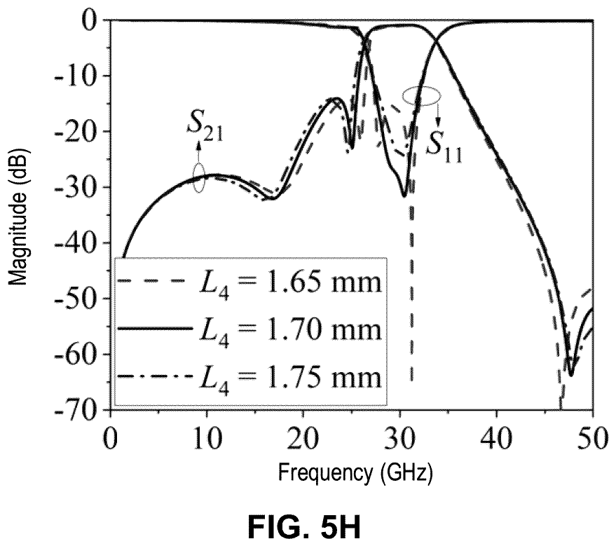

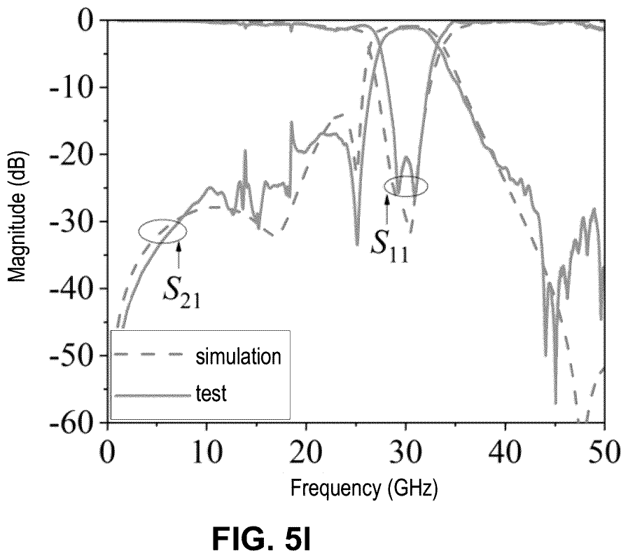

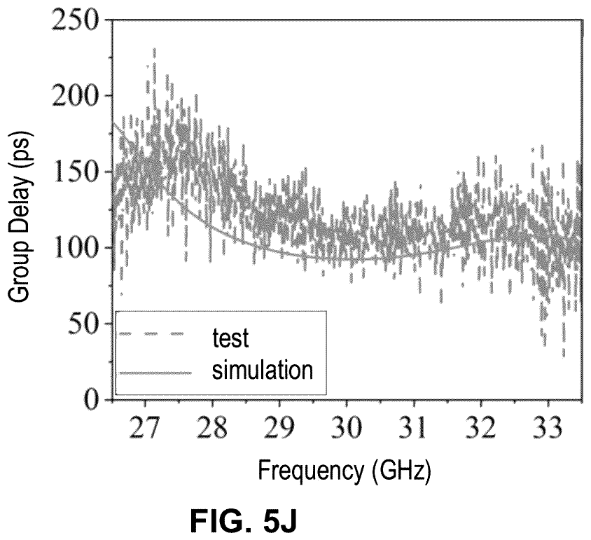

Extending a dual-mode T-stub structure from each ground metal plate 511, 512 can further improve the performance of the filter. The two dual-mode T-stubs are equivalent to two quarter-wavelength resonators connected in parallel, which can reduce size and generate two TZs in a lower stopband. FIG. 5A illustrates a top view of a CPW-based mmWave bandpass filter 500 according to a certain embodiment of the present disclosure. Specifically, a first T-stub 571 is positioned in the second longitudinal gap 552 and connected to the first ground metal plate 511. A second T-stub 572 is positioned in the fourth longitudinal gap 554 and connected to the second ground metal plate 512. In the transverse direction, the first T-stub 571 is separated from the first and second CPW resonators 531, 532 by a fifth longitudinal gap 555, and the second T-stub 572 is separated from the third and fourth CPW resonators 533, 534 by a sixth longitudinal gap 556. The first and second T-stubs 571, 572 are symmetrically arranged with respect to the first midline 501.

Each T-stub 571, 572 comprises a longitudinal section 5711, 5721 and a transverse section 5712, 5722. The transverse section 5712 of the first T-stub 571 extends from a midpoint 5112 of a long side 5111, oriented closer to the first and second CPW resonators 531, 532, of the first ground metal plate 511 to a midpoint 5713 of a long side of the longitudinal section 5711 of the first T-stub 571. The long side of the longitudinal section 5711 can be either of its two long sides. The transverse section 5722 of the second T-stub 572 extends from a midpoint 5122 of a long side 5121, oriented closer to the third and fourth CPW resonators 533, 534, of the second ground metal plate 512 to a midpoint 5723 of a long side of the longitudinal section 5721 of the second T-stub 572. The long side of the longitudinal section 5721 can be either of its two long sides.

Though FIG. 5A shows the filter 500 with the T-slots and the T-stubs 571, 572. Filter comprising only T-stubs are within the protection scope of the present disclosure.

To achieve optimal performance, the inventors conducted plenty of simulations to investigate the relationship between the dimensions of each element and performance characteristics of the filter 500. When discussing the simulations shown in FIG. 5D, FIG. 5E, FIG. 5F, FIG. 5G, and FIG. 5H, please also refer to the notations indicated in FIG. 5B and FIG. 5C.

FIG. 5D illustrates the simulation results of frequency response varying with a length (L₃) of the longitudinal slot of each T-slot in the longitudinal direction in the filter 500. The simulation results show that a frequency of the TZ in the upper stopband is decreased if L₃ is increased. The simulation results also demonstrate that a center frequency of a passband of the filter 500 is reduced along with the growth of L₃.

FIG. 5E illustrates the simulation results of the center frequency varying with a length (L₂) of each CPW resonator 531, 532, 533, 534 in the longitudinal direction in the filter 500. The simulation results show that the center frequency is decreased as L₂ is increased.

FIG. 5F illustrates the simulation results of bandwidth of the passband varying with a width (g₂) of the first and second transverse gaps 541, 542 in the longitudinal direction in the filter 500. The simulation results show that the bandwidth is narrowed as g₂ is increased.

FIG. 5G illustrates the simulation results of the frequency response with and without the presence of the two T-stubs 571, 572 in the filter 500. The simulation results show that, when the two T-stubs 571, 572 are present in the filter 500, two TZs are generated in the lower stopband. This will significantly improve the performance of frequency selection. Meanwhile, the presence of the two T-stubs 571, 572 can decrease the center frequency of the passband so that a smaller size of the filter 500 is achievable.

FIG. 5H illustrates the simulation results of the frequencies of the two TZs in the lower stopband varying with a length (L₄) of the longitudinal section 5711, 5721 of each T-stub 571, 572 in the longitudinal direction in the filter 500. The simulation results show that the frequencies of the two TZs in the lower stopband are decreased as L₄ is increased.

Leveraging the above simulations, optimized dimensions of each element of the filter 500 can be acquired. On a qualitative scale, the following arrangements are suggested: (1) each T-slot is symmetric about the transverse midline of the correspondent CPW resonator 531, 532, 533, 534; (2) each T-stub 571, 572 is symmetric with respect to the second midline 502; (3) in the longitudinal direction, a total length of the first and second CPW resonators 531, 532 and the first transverse gap 541 is greater than a length of the central transverse gap 540 but less than a length of the CPW plane; (4) in the longitudinal direction, a total length of the third and fourth CPW resonators 533, 534 and the second transverse gap 542 is greater than the length of the central transverse gap 540 but less than the length of the CPW plane; (5) in the longitudinal direction, a length of the longitudinal section 5711 of the first T-stub 571 is greater than the total length of the first and second CPW resonators 531, 532 and the first transverse gap 541 but less than the length of the CPW plane; and (6) in the longitudinal direction, a length of the longitudinal section 5721 of the second T-stub 572 is greater than the total length of the third and fourth CPW resonators 533, 534 and the second transverse gap 542 but less than the length of the CPW plane.

In a preferred embodiment of the present disclosure, the following dimensions for each element of the filter 500 are deployed, with the notations as shown in FIG. 5A, FIG. 5B and FIG. 5C: (1) a thickness (h) of the LN substrate is about 0.15 mm, a length (L₀) of the LN substrate in the longitudinal direction is about 2 mm, and a width (W₀) of the LN substrate in the transverse direction is about 1.7 mm; (2) a thickness (t) of the CPW plane is about 0.01 mm; (3) a length (L₁) of the input and output signal transmission lines 521, 522 along the longitudinal direction is about 0.542 mm, and a width (W₁) of the input and output signal transmission lines 521, 522 along the transverse direction is about 0.2 mm; (4) the length (L₂) of each CPW resonator 531, 532, 533, 534 in the longitudinal direction is about 0.591 mm, and a width (W₂) of each CPW resonator 531, 532, 533, 534 in the transverse direction is about 0.15 mm; (5) the length (L₃) of the longitudinal slot of each T-slot in the longitudinal direction is about 0.4 mm, and a width (W₃) of the longitudinal slot of each T-slot in the transverse direction is about 0.05 mm; (6) the length (L₄) of the longitudinal section 5711, 5721 of each T-stub 571, 572 in the longitudinal direction is about 1.7 mm, a width (W₄) of the longitudinal section 5711, 5721 of each T-stub 571, 572 in the transverse direction is about 0.1 mm, a length (L₅) of the transverse section 5712, 5722 of each T-stub 571, 572 in the transverse direction is about 0.05 mm, and a width (W₅) of the transverse section 5712, 5722 of each T-stub 571, 572 in the longitudinal direction is about 0.4 mm; (7) a width (g₁) of the first and third longitudinal gap 551, 553 in the transverse direction is about 0.015 mm; (8) the width (g₂) of the first and second transverse gap 541, 542 in the longitudinal direction is about 0.08 mm; and (9) the length of the filter 500 is about 2 mm, the width of the filter 500 is about 1.7 mm, the thickness of the filter 500 is about 0.16 mm.

FIG. 5I illustrates the simulated and tested S-parameters of the filter 500 when applying the above proposed dimensions. FIG. 5J illustrates the simulated and tested group delay of the filter 500 when applying the above proposed dimensions. As shown in FIG. 5I and FIG. 5J, the filter 500 achieves the following performances in simulations: (1) a center frequency is 30 GHz; (2) a 3-dB relative bandwidth is 22.7%; (3) a minimum IL is 0.91 dB over a passband; (4) frequency of the TZ in the upper stopband is 47.76 GHz; (5) frequencies of the two TZs in the lower stopband are 16.84 GHz and 25.08 GHz; and (6) a maximum group delay is 183 ps. With reference to FIG. 5I and FIG. 5J, the actual test results are as follows: (1) the center frequency is 30.26 GHz; (2) the 3-dB relative bandwidth is 17%; (3) the minimum IL is 1.12 dB over a passband; (4) the frequency of the TZ in the upper stopband is 45.04 GHz; (5) the frequencies of the two TZs in the lower stopband are 15.19 GHz and 25.14 GHz; and (6) the maximum group delay is 232 ps.

Table 1 shows the comparison results of the performances among the filter 500 and the following filters: (A) the mmWave piezoelectric acoustic filter [10] with large IL; (B) the mmWave filters using PCB [1] technologies with large IL and large size; (C) the mmWave filters using LTCC [11] technologies with large IL and large size; and (D) the mmWave filters using IPD [12] technology with large IL and high cost.

TABLE 1
Comparison results of the performances among the proposed
filter 500 and other filters in the cited references.

| | f₀ | FBW | IL | Size | |
|---|---|---|---|---|---|
| Ref. | (GHz) | (%) | (dB) | (λ₀ × λ₀) | Cost |
| A | 23.5 | 18.2 | 2.38 | 0.059 × 0.058 | Low |
| B | 25.88 | 4.48 | 4.36 | 0.84 × 0.53 | Low |
| C | 27.95 | 3.7 | 2.8 | 0.57 × 0.3 | Medium |
| D | 94 | 32.7 | 4.3 | 0.254 × 0.078 | High |
| filter | 30.26 | 17 | 1.12 | 0.2 × 0.17 | Low |
| 500 | | | | | |

As evidenced by the results, the filter 500 successfully realizes a mmWave bandpass filter characterized by high selectivity, miniaturization, and cost-effectiveness. The introduction of the TZ in the upper stopband with the T-slots and the two TZs in the lower stopband with the T-stubs 571, 572 can significantly improve the frequency selectivity of the filter. The low-cost LN crystal, as the substrate, is characterized by its small loss tangent and high permittivity, achieving low IL over the passband and miniaturization in size. Therefore, taking advantage of using LN crystal as the substrate and introducing multiple TZs in the upper and lower stopbands, a mmWave bandpass filter with high selectivity, miniaturization and low cost is achievable.

C.4 CPW-Based mmWave Filter with a Cross-Shaped Dual-Mode Resonator

In a certain embodiment of the present disclosure, a cross-shaped dual-mode resonator is integrated onto the CPW plane of the filter, thereby increasing the order of the filter to the fourth order, which is beneficial to increase the bandwidth. FIG. 6A illustrates a top view of a CPW-based mmWave bandpass filter 600 according to a certain embodiment of the present disclosure. Instead of T-slot, an I-slot is embedded into each CPW resonator 631, 632, 633, 634. Specifically, first, second, third and fourth I-slots 661, 662, 663, 664 are embedded into the first, second, third and fourth CPW resonators 631, 632, 633, 634, respectively. The first and third I-slots 661, 663 are symmetrically arranged with respect to the first midline 601, the second and fourth I-slots 662, 664 are symmetrically arranged with respect to the first midline 601, the first and second I-slots 661, 662 are symmetrically arranged with respect to the second midline 602, and the third and fourth I-slots 663, 664 are symmetrically arranged with respect to the second midline 602. A height of each I-slot 661, 662, 663, 664 is equal to a thickness of its respective CPW resonator 631, 632, 633, 634.

Each I-slot, taking the third I-slot 663 as an example as shown in FIG. 6B, comprises a single transverse slot 6632. The single transverse slot 6632 extends from a midpoint 6334 of a first long side 6333, oriented away from the middle signal region 650, of the third CPW resonator 633 towards a midpoint 6336 of a second long side 6335, oriented closer to the middle signal region 650, of the third CPW resonator 633, without extending through the second long side 6335. The single transverse slot 6632 extends along a transverse midline 6332 of the third CPW resonator 633. In this way, the third I-slot 663 shapes the third CPW resonator 633 into a rectangular strip comprising a notch positioned at the midpoint 6334 of the long side 6333 of the rectangular strip. The notch is oriented away from the middle signal region 650. Though the third I-slot 663 is illustrated as an example, the first, second and fourth I-slots 661, 662, 664 have similar configurations.

The cross-shaped dual-mode resonator 680 is disposed in a center area of the signal region 603. The cross-shaped dual-mode resonator 680 comprises a longitudinal arm 681 and a transverse arm 682.

The longitudinal arm 681 is positioned in the central transverse gap 640, extending along the first midline 601. The longitudinal arm 681 is separated from the input signal transmission line 621 by a third transverse gap 643 and from the output signal transmission line 622 by a fourth transverse gap 644. The longitudinal arm 681 is symmetric with respect to the first and second midlines 601, 602. The third and fourth transverse gaps 643, 644 are each symmetric with respect to the first midline 601. The third and fourth transverse gaps 643, 644 are arranged symmetric with respect to the second midline 602.

The transverse arm 682 is also symmetric with respect to the first and second midlines 601, 602, extending along the second midline 602. A first end 6821 of the transverse arm 682 is separated from the first ground metal plate 611 by a seventh longitudinal gap 657. A second end 6822 of the transverse arm 682 is separated from the second ground metal plate 612 by an eighth longitudinal gap 658. The seventh and eighth longitudinal gaps 657, 658 are each symmetric with respect to the second midline 602.

The seventh longitudinal gaps 657 extends deep into interior of the first ground metal plate 611, such that an inward recess is formed near a midpoint of a long side 6111, oriented closer to the transverse arm 682, of the first metal plate 611. An edge 6823 of the first end 6821 can be substantially flush with the long side 6111 or extend into the inward recess. The second end 6822 is symmetrically arranged relative to the first end 6821 about the first midline 601, and the eighth longitudinal gap 658 is symmetrically arranged relative to the seventh longitudinal gap 657 about the first midline 601.

FIG. 6C illustrates the simulated S-parameters of the filter 600. The center frequency is 31.73 GHz and the FBW is 53.3%. The minimum passband IL is 0.9 dB, while the return loss at 31.73 GHz is 43 dB. The stopband suppression level is larger than 20 dB. The total size is 3.14 mm×1.65 mm.

In conclusion, the proposed EM CPW-based mmWave bandpass can realize low passband IL, high out-band suppression, and small size.

It will further be appreciated that any of the features in the above embodiments of the disclosure may be combined together and are not necessarily applied in isolation from each other. Similar combinations of two or more features from the above embodiments or preferred forms of the disclosure can be readily made by one skilled in the art.

Unless otherwise defined, the technical and scientific terms used herein have the plain meanings as commonly understood by those skill in the art to which the example embodiments pertain. Embodiments are illustrated in non-limiting examples. Based on the above disclosed embodiments, various modifications that can be conceived of by those skilled in the art would fall within spirits of the example embodiments.

### CITED REFERENCES

[1]L. Zhu, S. Yang, T. Gao, et al., “A design method to realize manufacture-friendly millimeter-wave folded substrate integrated waveguide bandpass filters”, IEEE Transactions on Circuits and Systems II: Express Briefs, 70(3), 979-983, 2023.
[2]Y. Li, L. A. Yang, L. Du, et al., “Design of millimeter-wave resonant cavity and filter using 3-D substrate-integrated circular waveguide”, IEEE Microwave and Wireless Components Letters, 27(8), 706-708, 2017.
[3]M. G. Bautista, H. Zhu, X. Zhu, et al., “Compact millimeter-wave bandpass filters using quasi-lumped elements in 0.13-um (Bi)-CMOS technology for 5G wireless systems”, IEEE Transactions on Microwave Theory and Techniques, 67(7), 3064-3073, 2019.
[4]G. Shen, W. Che, W. Feng, et al., “Low insertion-loss MMIC bandpass filter using lumped-distributed parameters for 5G millimeter-wave application”, IEEE Transactions on Components, Packaging and Manufacturing Technology, 11(1), 98-108, 2021.
[5]Z. Ge, L. Chen, R. Gómez-García, et al., “Millimeter-wave wide-band bandpass filter in CMOS technology using a two-layered highpass-type approach with embedded upper stopband”, IEEE Transactions on Circuits and Systems II: Express Briefs, 68(5), 1586-1590, 2021.
[6]L. Gao, G. M. Rebeiz, “Wideband bandpass filter for 5G millimeter-wave application in 45-nm CMOS silicon-on-insulator”, IEEE Electron Device Letters, 42(8), 1244-1247, 2021.
[7]H. Wu, Y. Wu, Z. Lai, et al. A hybrid film-bulk-acoustic-resonator/coupled-line/transmission-line high selectivity wideband bandpass FBAR filter. IEEE Transactions on Microwave Theory and Techniques, 2020, 68(8): 3389-3396.
[8]R. Zhang, M. Abdelfattah, L. Yang, et al. A hybrid low-cost bandpass filter with SAW resonators and external lumped inductors using a dual-coupling scheme. IEEE Transactions on Microwave Theory and Techniques, 2020, 68(6): 2289-2299.
[9]T. Cai, C. Chen, X. Zhang, et al. A hybrid transmission-line/SAW-resonator analog signal-interference dual-band bandpass filter. IEEE Microwave and Wireless Components Letters, 2020, 30(1): 27-30.
[10]O. Barrera et al., “Thin-film lithium niobate acoustic filter at 23.5 GHz with 2.38 dB IL and 18.2% FBW,” J. Microelectromech. Syst., vol. 32, no. 6, pp. 622-625, December 2023.
[11]K. S. Chin et al., “LTCC multilayered substrate-integrated waveguide filter with enhanced frequency selectivity for system-in-package applications,” IEEE Trans. Compon. Packag. Manuf. Technol., vol. 4, no. 4, pp. 664-672, April 2014.
[12]Q. Lu et al., “W-band compact triple-mode bandpass filter using multistub resonator in 65-nm CMOS technology,” IEEE Microw. Wireless Technol. Lett., vol. 34, no. 12, pp. 1319-1322, December 2024.

What is claimed is:

1. A coplanar waveguide based (CPW-based) millimeter-wave bandpass filter comprising:
a substrate;
first and second ground metal plates each coupled to ground and disposed on a rectangular CPW plane at a top surface of the substrate, wherein the first and second ground metal plates extend continuously from a first end to a second end of the CPW plane along a longitudinal direction of the CPW plane and are positioned on opposite sides of the CPW plane in a transverse direction of the CPW plane, thereby defining a signal region between the first and second ground metal plates, and wherein the signal region extends continuously along the longitudinal direction;
an input signal transmission line and an output signal transmission line respectively positioned at two ends of the signal region in the longitudinal direction and each aligned with a first midline, the first midline being a midline of the CPW plane in the longitudinal direction, wherein the input and output signal transmission lines are symmetrically arranged with respect to a second midline, the second midline being a midline of the CPW plane in the transverse direction, wherein the input signal transmission line is separated from the output signal transmission line by a central transverse gap, and wherein a middle signal region is composed of the input and output signal transmission lines and the central transverse gap;
first and second CPW resonators each longitudinally arranged between the first ground metal plate and the middle signal region, wherein the first CPW resonator is separated from the second CPW resonator by a first transverse gap, the first transverse gap being aligned with the second midline, and wherein, in the transverse direction, the first and second CPW resonators are separated from the middle signal region by a first longitudinal gap and from the first ground metal plate by a second longitudinal gap; and
third and fourth CPW resonators each longitudinally arranged between the second ground metal plate and the middle signal region, wherein the third CPW resonator is separated from the fourth CPW resonator by a second transverse gap, the second transverse gap being aligned with the second midline, and wherein, in the transverse direction, the third and fourth CPW resonators are separated from the middle signal region by a third longitudinal gap and from the second ground metal plate by a fourth longitudinal gap,
wherein the first and third CPW resonators are symmetrically arranged with respect to the first midline, the second and fourth CPW resonators are symmetrically arranged with respect to the first midline, the first and second CPW resonators are symmetrically arranged with respect to the second midline, and the third and fourth CPW resonators are arranged symmetrically metrical about the second midline.

2. The filter according to claim 1, wherein:
in the longitudinal direction, a total length of the first and second CPW resonators and the first transverse gap is greater than a length of the central transverse gap but less than a length of the CPW plane, and
in the longitudinal direction, a total length of the third and fourth CPW resonators and the second transverse gap is greater than the length of the central transverse gap but less than the length of the CPW plane.

3. The filter according to claim 1, wherein:
first, second, third and fourth T-slots are embedded into the first, second, third and fourth CPW resonators, respectively,
the first and third T-slots are symmetrically arranged with respect to the first midline, the second and fourth T-slots are symmetrically arranged with respect to the first midline, the first and second T-slots are symmetrically arranged with respect to the second midline, and the third and fourth T-slots are symmetrically arranged with respect to the second midline,
each T-slot of the first, second, third and fourth T-slots embedded into its respective CPW resonator has a height equal to a thickness of the respective CPW resonator, and
each T-slot comprises:
a longitudinal slot extending along a longitudinal midline of the respective CPW resonator; and
a transverse slot extending from a midpoint of a long side of the longitudinal slot to a midpoint of a long side, oriented away from the middle signal region, of the respective CPW resonator,
wherein each T-slot shapes the respective CPW resonator into a rectangular ring comprising a notch positioned at a midpoint of a long side of the rectangular ring, and wherein the notch is oriented away from the middle signal region.

4. The filter according to claim 3, wherein each T-slot is symmetric with respect to a transverse midline of the respective CPW resonator.

5. The filter according claim 3, wherein a transmission zero in an upper stopband is achievable by the first, second, third and fourth T-slots.

6. The filter according to claim 1 further comprising:
a first T-stub positioned in the second longitudinal gap and connected to the first ground metal plate, wherein, in the transverse direction, the first T-stub is separated from the first and second CPW resonators by a fifth longitudinal gap; and
a second T-stub positioned in the fourth longitudinal gap and connected to the second ground metal plate, wherein, in the transverse direction, the second T-stub is separated from the third and fourth CPW resonators by a sixth longitudinal gap,
wherein:
the first and second T-stubs are symmetrically arranged with respect to the first midline,
each T-stub of the first and second T-stubs comprises a longitudinal section and a transverse section,
the transverse section of the first T-stub extends from a midpoint of a long side, oriented closer to the first and second CPW resonators, of the first ground metal plate to a midpoint of a long side of the longitudinal section of the first T-stub, and
the transverse section of the second T-stub extends from a midpoint of a long side, oriented closer to the third and fourth CPW resonators, of the second ground metal plate to a midpoint of a long side of the longitudinal section of the second T-stub.

7. The filter according to claim 6, wherein:
in the longitudinal direction, a length of the longitudinal section of the first T-stub is greater than a total length of the first and second CPW resonators and the first transverse gap but less than a length of the CPW plane, and
in the longitudinal direction, a length of the longitudinal section of the second T-stub is greater than a total length of the third and fourth CPW resonators and the second transverse gap but less than the length of the CPW plane.

8. The filter according to claim 6, wherein each T-stub is symmetric with respect to the second midline.

9. The filter according to claim 6, wherein two transmission zeros in a lower stopband are achievable by the first and second T-stubs.

10. The filter according to claim 1 further comprising a cross-shaped dual-mode resonator, the cross-shaped dual-mode resonator comprising:
a longitudinal arm positioned in the central transverse gap and extending along the first midline, and
a transverse arm extending along the second midline,
wherein:
the longitudinal arm is separated from the input signal transmission line by a third transverse gap and from the output signal transmission line by a fourth transverse gap,
the longitudinal arm is symmetric with respect to the first and second midlines, the third and fourth transverse gaps are each symmetric with respect to the first midline, and the third and fourth transverse gaps are arranged symmetric with respect to the second midline,
the transverse arm is separated from the first ground metal plate by a seventh longitudinal gap and from the second ground metal plate by an eighth longitudinal gap,
the transverse arm is symmetric with respect to the first and second midlines, the seventh and eighth longitudinal gaps are each symmetric with respect to the second midline, and the seventh and eighth longitudinal gaps are symmetrically arranged with respect to the first midline,
the seventh longitudinal gap extends deep into interior of the first ground metal plate, such that a first inward recess is formed near a midpoint of a long side, oriented closer to the transverse arm, of the first ground metal plate, and
the eighth longitudinal gap extends deep into interior of the second ground metal plate, such that a second inward recess is formed near a midpoint of a long side, oriented closer to the transverse arm, of the second ground metal plate.

11. The filter according to claim 10, wherein:
first, second, third and fourth I-slots are embedded into the first, second, third and fourth CPW resonators, respectively,
the first and third I-slots are symmetrically arranged with respect to the first midline, the second and fourth I-slots are symmetrically arranged with respect to the first midline, the first and second I-slots are symmetrically arranged with respect to the second midline, and the third and fourth I-slots are symmetrically arranged with respect to the second midline,
each I-slot of the first, second, third and fourth I-slots embedded into its respective CPW resonator has a height equal to a thickness of the respective CPW resonator,
each I-slot comprises a single transverse slot extending from a midpoint of a first long side, oriented away from the middle signal region, of the respective CPW resonator, towards a midpoint of a second long side, oriented closer to the middle signal region, of the respective CPW resonator without extending through the second long side, and
each I-slot shapes the respective CPW resonator into a rectangular strip comprising a notch positioned at a midpoint of a long side of the rectangular strip, and the notch is oriented away from the middle signal region.

12. The filter according to claim 10, wherein bandwidth of the filter is increased by adding the cross-shaped dual-mode resonator.

13. The filter according to claim 1, wherein the substrate is a lithium niobate (LiNbO₃) substrate.
